(19) United States
(12) Patent Application Publication
(10) Pub. No.: US 2016/0221217 A1
(43) Pub. Date: Aug. 4, 2016

(54) POWDER PRESS FOR PRODUCING PRESSED PARTS MADE OUT OF POWDERED PRESSING MATERIAL

(71) Applicant: Fette Compacting GmbH, Schwarzenbek (DE)

(72) Inventors: Holger Lünstedt, Reinbek (DE); Thomas Pannewitz, Klein Pampau (DE); Andreas Groth, Schwarzenbek (DE); Andreas Teetzen, Schwarzenbek (DE)

(21) Appl. No.: 15/015,012

(22) Filed: Feb. 3, 2016

(30) Foreign Application Priority Data
Feb. 4, 2015 (DE) 10 2015 101 586.2

(51) Int. Cl. B28B 17/00; B28B 3/08

(52) U.S. Cl. CPC B28B 17/0081; B28B 3/086

(57) ABSTRACT

A powder press for producing pressed parts from powdered pressing material has a die plate with at least two dies or die holes, at least two upper stamps and at least two lower stamps, which cooperate with the die hole, at least one linear drive for each upper stamp and/or at least one linear drive for each lower stamp, at least one position sensor for each upper stamp and/or each lower stamp between linear drive and upper stamp and/or at least one position sensor for each lower stamp between linear drive and lower stamp, and a regulator for each of the linear drives for upper stamps and/or lower stamps respectively. Each upper stamp and/or lower stamp is connected to a force transmission bridge in terms of function, on which two linear drives act, which are arranged spaced apart in parallel.

### CROSS-REFERENCE TO RELATED APPLICATION

This application claims priority to German Patent Application No. 10 2015 101 586.2, filed Feb. 4, 2015, the content of which is incorporated herein in its entirety by reference.

### TECHNICAL FIELD

The disclosure relates to a powder press for producing pressed parts made out of powdered pressing material.

### TECHNICAL FIELD

It is known to produce preforms made out of carbide, ceramics, ceramic metals or the like by means of presses. The powdered or granular material is formed into a preform, which is then subjected to a sintering process, by means of presses. A press may include an upper stamp and a lower stamp, which cooperate with a die or respectively a die hole in a die plate. The stamps are driven by a suitable power drive, for example a hydraulic cylinder. The die plate may be arranged in a fixed manner and to move upper stamp and lower stamp or alternatively to shift only the upper stamp and the die plate, while the lower stamp remains stationary.

A powder press from EP 566 231 B1 allows at least two pressed parts to be produced at the same time. For this, separate lower stamps are provided, which each cooperate with a die hole. The separate lower stamps are each scanned by a separate position sensor and force sensor and controlled by means of a respective regulating installation. A common force transmission bridge with a common position sensor and a common force sensor is provided for the upper stamps. A cylindrical ring arrangement for the activation of two separate lower stamps is shown in an example. The arrangement can be used to activate the upper stamps separately.

### SUMMARY

The non-centric arrangement of the upper stamps and/or lower stamps in EP 566 231 B1 gives rise to lateral forces on the drive cylinders and guiding units, which can cause considerable wear. It is not possible to compensate for tilting or the desired, differentiated impact of forces on the stamps by conventional means.

In contrast, the teachings herein describe a powder press with which a plurality of pressed forms can be simultaneously produced with reduced wear in a narrow space.

One powder press described herein includes a die plate with at least two dies or one die with at least two die holes, at least two upper stamps which cooperate with the dies or respectively die holes, at least two lower stamps which cooperate with the dies or respectively die holes, at least one linear drive for each upper stamps and/or lower stamps, at least one position sensor for each upper stamp and/or at least one position sensor for each lower stamp, and a regulator for each of the linear drives for upper stamps and/or lower stamps respectively. At least each upper stamp and/or lower stamp is, in terms of function, connected to a force transmission bridge on which two linear drives act, which are arranged spaced apart in parallel.

Regardless of whether the drive forces of the linear drives act on the force transmission bridges or respectively the stamp carriers symmetrically, tilting can be compensated with the powder press so that no wear problems arise in this regard. Furthermore, different drive forces can be exerted on the force transmission bridges or respectively the stamp carriers in a targeted manner if this is advantageous for giving the pressed part a corresponding design. Additionally, unequal stamp lengths of the upper stamp axis can be evened out with the powder press described herein, which works with separate upper stamps and lower stamps in any event.

In particular, the powder press enables a higher output of pressed parts and a prevention of increased wear. Despite the higher output per unit of time, a better quality of the pressed parts is achieved.

According to one embodiment of the teachings herein, the linear drives have electrically driven spindle drives, with which the linearly movable drive part is connected to the force transmission bridge in terms of function (e.g., they are functionally connected). With a spindle drive, either the spindle nut or respectively a worm wheel or the spindle rod is known to be stationary. How the spindle drive is connected to the press stamp in terms of function depends on the structural requirements of the gear options.

Since there are two force paths with respect to a stamp, it is advantageous to measure the positions and the transmitted forces in each force path. Conventional force sensors are complex. It is therefore very advantageous if, according to an additional embodiment of the teachings herein, a piezo sensor is arranged in the force path of the linear drives of the upper stamps and/or lower stamps. In this way, precisely regulating each force path in order to prevent tilting or to introduce different forces is quite possible.

According to one embodiment of the teachings herein, the force transmission bridge closer to the die plate has an opening through which the upper stamp and/or lower stamp of the other force transmission bridge can pass. In this way, the powder press can be built very small.

In the following, an exemplary embodiment of the invention is to be explained in greater detail.

### BRIEF DESCRIPTION OF THE DRAWING

FIG. 1 shows a diagrammatic representation of drives for two upper stamps of a powder press according to one embodiment of the teachings herein and the regulation of the powder press for the upper stamps.

### DETAILED DESCRIPTION

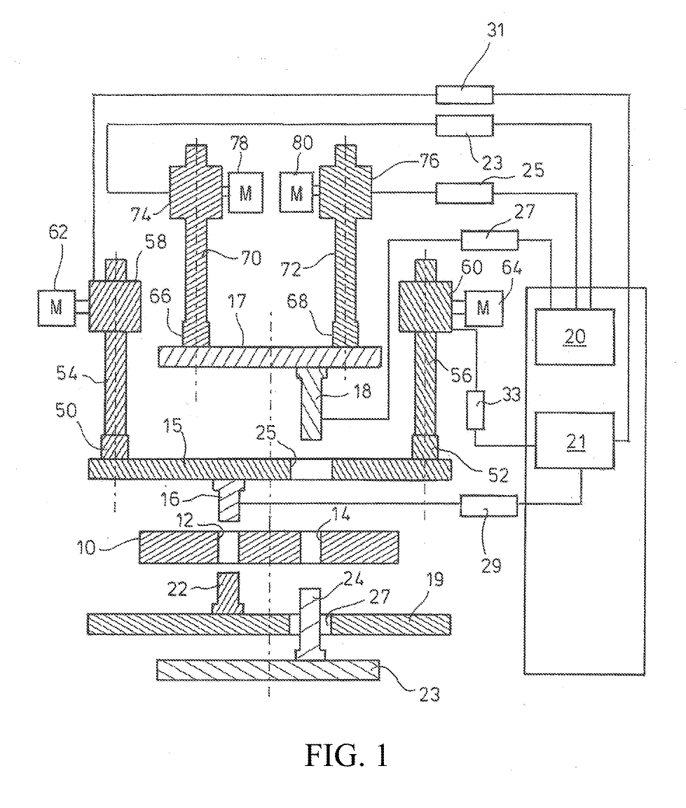

FIG. 1 shows a die plate 10 with two die holes 12, 14. A first upper stamp 16 is fitted to a force transmission bridge 15 and a second upper stamp 18 to a force transmission bridge 17. The upper stamps 16, 18 cooperate with the die holes 12, 14 in a known manner. A lower stamp 22 is fitted to an additional force transmission bridge 19. An additional lower stamp 24 is fitted to a fourth force transmission bridge 23. The lower stamps 22, 24 cooperate with the die holes 12, 14 in a known manner. The upper stamp 18 extends through an opening 25 in the force transmission bridge 15, and the lower stamp 24 extends through an opening 27 of the force transmission bridge 19.

Bearings 50, 52 for spindle rods 54, 56 are arranged on the force transmission bridge 15 at opposite ends. The spindle rods 54, 56 extend upwards into gears 58, 60, which are connected to respectively to an electric drive motor 62, 64. When the motors 62, 64 rotate, the spindle rods 54, 56 move axially and therefore activate the force transmission bridge 15 and with it the upper stamp 16. Analogously, on the force transmission bridge 17, an arrangement of two bearings 66, 68 is provided for respective spindle rods 70, 72, which extend through respective gears 74, 76, which are in turn connected to respective electric motors 78, 80. The activation via the shown gears for the upper stamp 18 corresponds to that for the upper stamp 16.

The lower stamps 22, 24, or respectively the force transmission bridges 19, 23, are driven by analogous spindle drives. They have been omitted for the purposes of simple illustration.

As described two linear drives have an impact on each of the stamps shown. A force sensor (not shown), for example a piezo sensor, is arranged in each force path for each linear drive, in order to either equalize or produce in a differentiated manner the regulation of the forces having an impact on the force transmission bridges 15, 17.

FIG. 1 shows only a portion of a powder press to illustrate the teachings herein. The powder press will generally include a frame surrounding the structure of FIG. 1, and guides for the force transmission bridges 15, 17, 19, 23. In an alternative implementation, the stamps 16, 18, 22, 24 may not be directly connected to the force transmission bridges 15, 17, 19, 23. Instead, the stamps 16, 18, 22, 24, via suitable tool carriers or respectively stamp carriers, may be otherwise functionally connected to the force transmission bridges 15, 17, 19, 23.

FIG. 1 also indicates the regulation of the upper stamps 16, 18, namely by means of one or more control devices or regulators indicated by block 20 for the upper stamp 18 and by block 21 for the upper stamp 16. A position sensor 23 is assigned to the gears 74, and a position sensor 25 is assigned to the gears 76. A force sensor 27 is assigned to the upper stamp 18, and a force sensor 29 is assigned to the upper stamp 16. A position sensor 31 is assigned to the gears 58, and a position sensor 33 is assigned to the gears 60. The regulations in the control devices 20 and 21 regulate the shifting of the force transmission bridges 15, 17 via the data of the position sensors and force sensors. Control is achieved either synchronously, so as to prevent the upper stamps 16, 18 tilting or by deliberately applying different loads to the force transmission bridges 15, 17, as required. Because the drives, of which each force transmission bridge has two, can be regulated separately, the various functions can be achieved. For clarity, FIG. 1 does not show the lines of action (e.g., the control lines) from the control devices 20 and 21 to the drive motors 62, 64, 78, 80. The control devices 20, 21, may each be a combination of hardware and/or software configured to achieve the control described above. Further, while two control devices 20, 21 are shown, only one is needed so long as output signals can be sent to separately regulate the drives.

Analogously to the upper stamps 16, 18, position sensors, which are connected to a regulator (e.g., control device 20 or 21), can be assigned to the lower stamps 22, 24. Force sensors, which are connected to the regulators, can also be assigned to the linear drives for the force transmission bridges 19, 23. Hence, independent linear drives are provided for the respective lower stamps 22, 24.

The activation of the upper stamps 16, 18 or respectively lower stamps 22, 24 thus follows via separate regulators. With the arrangement shown, it is therefore possible to adjust precisely the force that is respectively exerted on the force transmission bridge 15, 17 or respectively the force transmission bridge 19, 23 by a linear drive or respectively a spindle drive. Tilting of the stamps 16, 18 can thereby be prevented. Making different forces have an impact on a force transmission bridge is additionally possible, if so desired. That is, different forces may be applied to different areas of the force transmission bridge if it is desirable for a particular application.

What is claimed is:

1. A powder press for producing pressed parts from powdered pressing material, comprising:
a die plate with at least two die holes;
at least two upper stamps and at least two lower stamps, an upper stamp of the at least two upper stamps and a lower stamp of the at least two lower stamps cooperating with a respective die hole of the at least two die holes;
at least one of a linear drive sensor for each upper stamp or a linear drive sensor for each lower stamp;
at least one of a position sensor for each upper stamp between a linear drive and the upper stamp or a position sensor for each lower stamp between a linear drive and the lower stamp; and
a control device that regulates linear drives for at least one of the at least two upper stamps or the at least two lower stamps, wherein at least one of:
each upper stamp is connected to a force transmission bridge, on which two linear drives are arranged spaced apart in parallel, or
each lower stamp is connected to a force transmission bridge, on which two linear drives are arranged spaced apart in parallel.

2. The powder press according to claim 1, wherein each linear drive is an electrically driven spindle drive, with which a linearly movable drive part is connected to the force transmission bridge in terms of function.

3. The powder press according to claim 1, wherein force sensors are arranged in the force path between a stamp pair comprising an upper stamp of the at least two upper stamps and a lower stamp of the at least two lower stamps.

4. The powder press according to claim 3, wherein the force sensors are piezo sensors.

5. The powder press according to claim 1, wherein the force transmission bridge nearer the die plate has an opening through which at least one of an upper stamp or a lower stamp of the other force transmission bridge can pass.

6. A powder press for producing pressed parts from powdered pressing material, comprising:
a die plate with at least two die holes;
a first upper stamp arranged above a surface of the die plate;
a second upper stamp arranged above the surface of the die plate;
a first lower stamp arranged below the surface of the die plate and cooperating with the first upper stamp and a first die hole of the at least two die holes;
a second lower stamp arranged below the surface of the die plate and cooperating with the second upper stamp and a second die hole of the at least two die holes;
at least two of:
a first force transmission bridge, on which at least two linear drives are arranged spaced apart in parallel, and connected to the first upper stamp for movement of the first upper stamp;
a second force transmission bridge, on which at least two linear drives are arranged spaced apart in parallel, and connected to the second upper stamp for movement of the second upper stamp;
a third force transmission bridge, on which at least two linear drives are arranged spaced apart in parallel, and connected to the first lower stamp for movement of the first lower stamp; or
a fourth force transmission bridge, on which at least two linear drives are arranged spaced apart in parallel, and connected to the second lower stamp for movement of the second lower stamp;
a respective linear drive sensor for each linear drive;
a respective position sensor for each of the first upper stamp, the second upper stamp, the first lower stamp, and the second lower stamp that is connected for movement; and
at least one control device that receives input signals from the linear drive sensor and the position sensors and separately regulates movement by each linear drive.

7. The powder press according to claim 6, wherein the first force transmission bridge is closer to the die plate than the second force transmission bridge, and the first transmission bridge has an opening through the second upper stamp can pass to reach the die plate.

8. The powder press according to claim 7, wherein the third force transmission bridge is closer to the die plate than the fourth force transmission bridge, and the third transmission bridge has an opening through the second lower stamp can pass to reach the die plate.

9. The powder press according to claim 6, wherein each of the first force transmission bridge, the second force transmission bridge, the third force transmission bridge, and the fourth force transmission bridge has only two linear drives each, for a total of eight linear drives; and wherein each of the eight linear drives is a spindle drive.

10. The powder press according to claim 6, wherein the at least one control device comprises a respective control device for each of the first upper stamp, the second upper stamp, the first lower stamp, and the second lower stamp.
